(19) United States
(12) Patent Application Publication
(10) Pub. No.: US 2003/0019376 A1
(43) Pub. Date: Jan. 30, 2003

(54) Printing machine with die cutter handles

(76) Inventor: Joseph S. Gary IV, Stewartstown, PA (US)

Correspondence Address: Ronald B. Sherer, 103 South Shaffer Drive, New Freedom, PA, 17349, US

(21) Appl. No.: 09/911,948

(22) Filed: Jul. 24, 2001

(51) Int. Cl. B41F 1/00

(52) U.S. Cl. 101/226

(57) ABSTRACT

Removable handles are disclosed for attaching to die boards for installation and removal from die cutter machines in a printing machine.

### FIELD

This invention relates to printing machines including at least one die cutter section for diecutting or scoring individual sheets of material as they pass through the printing machine, and more particularly, to substantially improved handles for attaching and detaching the “die boards” to and from the rotary die cylinder.

### BACKGROUND

In the field of rotary printing machines, for printing on sheets of corrugated cardboard, for example, it is well known that the printed sheets must be cut and/or scored so as to fold and form end displays or cartons. It is also well known, such as disclosed in U.S. Pat. No. 4,878,407, to mount the cutter blades on a shell or “die board” which is removably connected to the die cutter cylinder; said patent being hereby incorporated by reference. The elongated die boards are generally composed of wood, and are both heavy and awkward to attach and detach from the die cylinder such that it is known to provide handles at the opposite longitudinal ends of the die board. Handles in the form of cut-outs are disclosed in the above stated patent, and it is also known to provide removable handles which are temporarily attached to the die board when it is desired to mount or demount a die board on or from the die cylinder. However, such removable handles have been heavy and awkward in themselves, difficult to attach and detach, and composed of stainless steel which makes them very expensive.

### SUMMARY

The present invention provides handles and a handle locking system for die boards which are easy and quick to attach or remove, and which are both light weight and inexpensive.

### BRIEF DESCRIPTION OF DRAWINGS

FIG. 1 illustrates a die cylinder and die board of the prior art;

FIG. 2 is a perspective view of the handle and locking system of the present invention;

FIG. 3 is a side elevational view, partly in cross-section, illustrating the locking elements of the handle and die board; and

FIG. 4 is a schematic perspective view showing one removable handle of the invention secured to a die board, and the mounting insert for securing a second handle.

### DETAILED DESCRIPTION

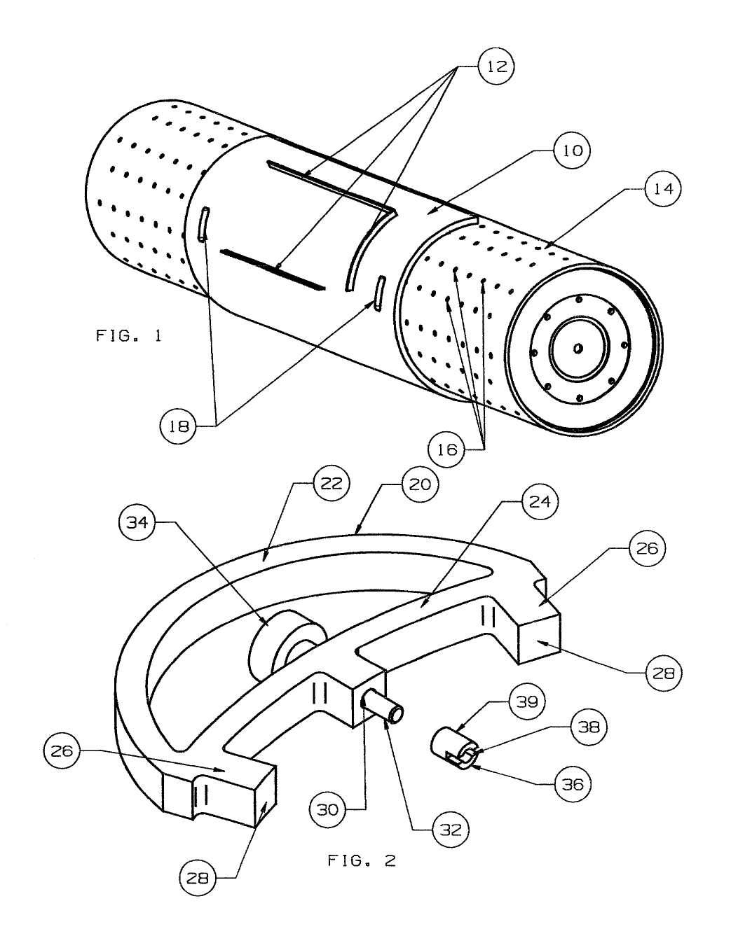

Referring first to the prior art, FIG. 1 illustrates a die board 10 carrying cutters 12 mounted on a die cylinder 14. In the illustrated prior art, the die board is maintained on the cylinder by virtue of a negative pressure within the hollow cylinder which draws the die board against the cylinder through a plurality of valves 16. However, it will be understood that other forms of vacuum and/or mechanical attachment may be used with the present invention such as bolts, locking rings, etc. FIG. 1 also illustrates one cut-out handle 18, and it will be understood that a second handle is provided in the cut-off right-hand end of the die board. However, such cut-out handles are difficult to use and may cause pinched fingers as the die board engages the cylinder.

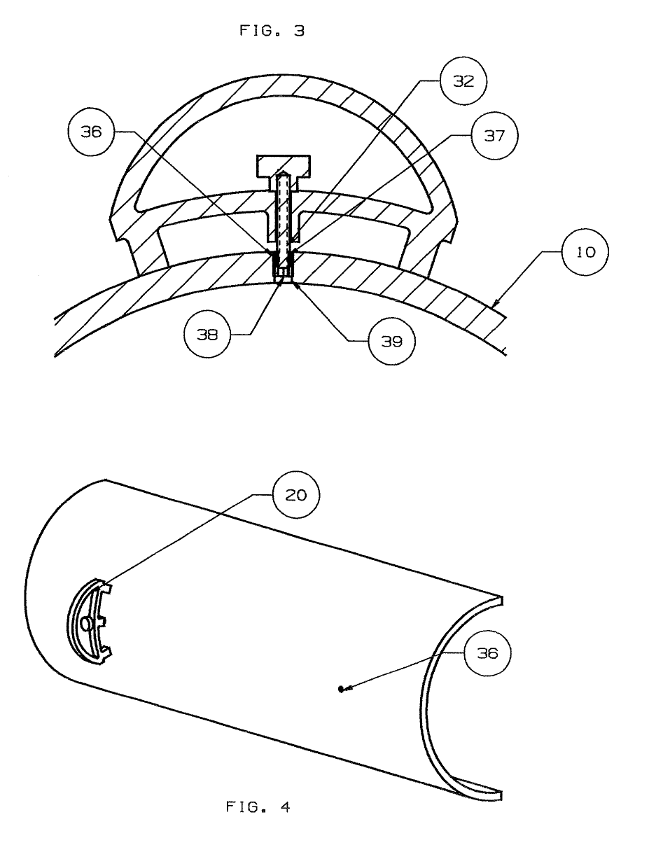

Referring to FIGS. 2 and 3, one handle 20 of the present invention is illustrated in detail. The handle comprises a curved gripping portion 22, a bridge portion 24 which extends from one end of the curved gripping portion to the other, and a pair of stand-off legs 26. Legs 26 include curved surfaces 28 which match the curvature of the die board when the legs engage the die board, and legs 26 are one-piece integral portions of the handle.

Bridge portion 24 includes a passage 30 through which a threaded bolt or pin 32 extends. Threaded pin 32 includes an enlarged head portion 34 which preferably includes a high friction surface 35 such as a knurled surface or a coating of high friction material. Head 34 may be integral with the pin, or the head may comprise a plastic knob securely connected to the pin such as by adhesives, locking pins or other connectors. As further shown in FIGS. 2-3, the second element of the locking system comprises an insert 36 having internal threads 37 which is inserted into the die board in a permanent manner. For example, a hole of proper size may be drilled into the die board, and the exterior threads 39 of insert 36 may be screwed into the hole such that it is securely retained in the hole by friction. Preferably, insert 36 has self-tapping threads and a slot 38 so that the insert cuts the threads in the die board as it is screwed into the hole, and the leading portions of the insert on opposite sides of the slot are compressed so that the leading portions exert a strong frictional force against the hole in the die board. In addition, or alternatively, external threads 39 of the insert may be coated with locking materials such as glue, epoxy, etc. so as to permanently secure the insert in place in the die board with or without the provision of slot 38.

In use, a first handle 20 is placed on the die board with curved surfaces 28 engaging the die board, and threaded pin 32 is screwed into an insert 36 by rotating knob 34. Preferably, the external threads on the pin and internal threads 37 of the insert have a course pitch such that only a few turns of the knob are required to lock the handle to the die board. Thereafter, the same simple procedure is used to quickly attach a second handle to the opposite end of the die board, and both handles may be quickly removed by simply turning the knobs a few times in the opposite direction.

With respect to the compositions of the various parts, it is a feature of the invention that the handles are substantially lighter and of substantially lower cost than previously known. For example, it has been discovered that sturdy, rugged and long-term reusable handles may be cast from aluminum, or water or plasma jet-cut from standard stock aluminum sheets; such sheets having a preferred thickness in the order of ¾ to 1 inch. It has also been discovered that, for even lighter handles at lower cost, the handles may be molded of or cut from plastic such as reinforced polypropylene or Nylon® or other plastic materials. At the same time, however, it is preferred that inserts 36 and pins 32 be composed of metal.

From the foregoing description of one preferred embodiment of the invention, it will be apparent that numerous variations may be made in the invention by a person skilled in the art. Accordingly, it is to be understood that the foregoing description is intended to be illustrative of the principles of the invention, and not exhaustive thereof, and that the invention is intended to be limited only as set forth in the following claims interpreted under the doctrine of equivalents.

What is claimed is:

1. A printing machine, for printing on individual sheets passing through the printing machine, including a die cutter section for cutting or scoring each printed sheet comprising:
(a) at least one printing section for printing images on individual sheets as they pass through said printing section;
(b) a die cutter section including a diecutting cylinder and a longitudinally extending die board having cutters mounted thereon;
(c) a pair of handles mounted longitudinally spaced on said die board;
(d) each of said handles including a threaded pin; and
(e) a pair of threaded inserts in said die board for receiving said threaded pins.

2. The printing machine of claim 1 wherein each of said handles comprise a gripping portion and a bridge portion.

3. The printing machine of claim 2 wherein said threaded pin passes through said bridge portion.

4. The printing machine of claim 3 wherein said threaded pin includes an enlarged head portion, said enlarged head portion being positioned between said gripping portion and said bridge portion.

5. The printing machine of claim 2 wherein said handles are composed of aluminum.

6. The printing machine of claim 2 wherein said handles are composed of non-metallic material.

7. The printing machine of claim 1 including a pair leg portions on each handle for engaging said die board, said leg portions being one-piece integral portions of each of said handles.

8. An elongated die board for a die cutter comprising:
(a) a pair of handles spaced at opposite longitudinal ends of said die board;
(b) a pair of internally threaded inserts mounted in said die board at opposite longitudinal ends of said die board; and
(c) each of said handles including threaded element means of a size and shape for engaging said internally threaded inserts for removably mounting said handles on said die board.

9. The die board of claim 8 wherein:
(a) said handles include leg portion means for engaging said die board; and
(b) said leg portion means are integral and one-piece with said handles.

10. The die board of claim 9 wherein said handles and said leg portions are composed of a light alloy.

11. The die board of claim 10 wherein said handles are composed of plastic material.

12. The die board of claim 8 wherein said inserts include external self-threading threads for self-threading into said die board and a slot for providing two biased portions of said insert.

13. A handle for removable attachment to a die board of a die cutter comprising:
(a) a handle comprising an integral one-piece gripping portion, bridge portion and leg portion;
(b) threaded pin means extending through said bridge portion; and
(c) enlarged head means connected to said threaded pin means for manually rotating said threaded pin means.

14. The handle of claim 13 wherein said head means are positioned between said gripping portion and said bridge portion.

15. The handle of claim 13 wherein said handle is composed of one integral piece of aluminum.

16. The handle of claim 13 wherein said handle is composed of one integral piece of non-metallic material.

17. The handle of claim 16 wherein said handle is composed of plastic.

18. The handle of claim 13 in combination with an insert to be inserted into said die board, said insert comprising external threads for engaging said die board, and internal threads for engaging said threaded pin.

19. The handle of claim 18 in combination with a die cutter cylinder comprising one section of a printing machine.

20. The handle of claim 19 wherein said die board includes means for cutting or scoring corrugated cardboard as said corrugated cardboard passes through said printing machine.
